(19) United States
(12) Patent Application Publication
(10) Pub. No.: US 2016/0369363 A1
(43) Pub. Date: Dec. 22, 2016

(54) ALLOY STEEL FOR HIGH TOUGHNESS CONSTANT VELOCITY JOINT OUTER WHEEL AND METHOD OF MANUFACTURING THE SAME

(71) Applicant: Hyundai Motor Company, Seoul (KR)

(72) Inventor: Si-Yup LEE, Uiwang-si (KR)

(21) Appl. No.: 14/942,819

(22) Filed: Nov. 16, 2015

(30) Foreign Application Priority Data
Jun. 16, 2015 (KR) 10-2015-0084750

(51) Int. Cl. C21D 9/00; C21D 1/18; C21D 6/00; C21D 8/00; C22C 38/54; F16D 3/00; C22C 38/44; C22C 38/04; C22C 38/02; C22C 38/28; C22C 38/22; C21D 1/34; C22C 38/50

(52) U.S. Cl. CPC C21D 9/0068; C21D 1/34; C21D 1/18; C21D 6/002; C21D 6/005; C21D 6/008; C21D 8/005; C21D 6/004; C22C 38/54; C22C 38/50; C22C 38/44; C22C 38/04; C22C 38/02; C22C 38/28; C22C 38/22; F16D 3/00; F16D 2200/0021; F16D 2200/0082

(57) ABSTRACT

Alloy steel for a constant velocity joint outer wheel includes, based on a total weight of the alloy steel, 0.50 to 0.60 wt % C (carbon), 0.15 to 0.35 wt % Si (silicon), 0.4 to 0.8 wt % Mn (manganese), more than 0 to 0.03 wt % P (phosphorus), more than 0 to 0.035 wt % S (sulfur), more than 0 to 0.3 wt % Cu (copper), more than 0 to 0.00002 wt % O (oxygen), and a balance of Fe (iron).

### CROSS-REFERENCE TO RELATED APPLICATIONS

This application claims priority under 35 U.S.C. §119 to Korean Patent Application No. 10-2015-0084750, filed on Jun. 16, 2015, in the Korean Intellectual Property Office, the entirety of which is incorporated herein by reference.

### TECHNICAL FIELD

The present disclosure relates to alloy steel used in an outer wheel of a constant velocity joint for a vehicle and a method of manufacturing the same, and relates to alloy steel having improved tensile strength and impact strength by adding an alloy element and optimizing a heat-treating process thereof, and a method of manufacturing the same.

### BACKGROUND

Recently, in order to meet development of the vehicle industry and various demands of consumers, various conveniences have been developed. The weight of a vehicle has significantly increased due to installation of many conveniences by demands of the consumers, and thus there are problems in that fuel efficiency of the vehicle is reduced and the load applied to chassis parts is further increased.

In accordance with an increase in output of the vehicle due to mass production of the vehicle, it is more difficult to control the quality and as a result, the quality of parts is reduced, thus rapidly increasing consumer dissatisfaction. However, since there is no economical method for dealing with this, the cost for solving the aforementioned problems has rapidly increased.

Generally, a constant velocity joint is used in a front axle of a front-wheel-drive car, and refers to a device mechanically connecting the axles in order to transfer torque between the two axles. In more detail, the constant velocity joint is a type of universal joint that uniformly performs power transmission without a change in rotational angular velocity between driven axles that are not on a straight line with a front driving axle. Universal joints having a large corrugation angle are attached to both ends of the axle to offset the change in rotational angular velocity. Examples of constant velocity joints include a zeppa type, a birfield type, a weiss type, a tractor type, and the like. In addition, generally, a constant velocity joint is called a CV joint.

The constant velocity joint transfers driving power of an engine and a transmission to a wheel at a constant velocity even though the steering angle is changed. The constant velocity joint is generally constituted by an outer wheel, an inner wheel, a ball, a cage, and the like.

Particularly, the outer wheel of the constitution of the constant velocity joint receives the largest load of the vehicle due to the structural characteristic thereof, thus potentially threatening the safety of passengers or damage to the vehicle. Examples of a method for solving the problem include achieving a weight reduction of the vehicle and securing rigidity of the constant velocity joint outer wheel. Among the examples, an object of the present disclosure is to improve the quality of the vehicle by increasing rigidity of the constant velocity joint outer wheel of the vehicle and improve the durability of the constant velocity joint by using an alloy steel having superior strength and toughness. Further, safety of passengers may be secured, and moreover, environmental pollution may be prevented by improving the life of vehicle parts.

### SUMMARY OF THE DISCLOSURE

The present disclosure has been made in an effort to provide alloy steel used in a constant velocity joint outer wheel for a vehicle, which includes Fe (iron) as a main component, C (carbon), Si(silicon), Mn (manganese), P (phosphorus), S (sulfur), Cu (copper), Cr (chromium), Mo (molybdenum), Ni (nickel), Ti (titanium), B (boron), O (oxygen), and an inevitable impurity to increase strength, toughness, and the like and thus improve durability, and a method of manufacturing the same.

The present disclosure has also been made in an effort to provide a constant velocity joint outer wheel for a vehicle manufactured by the alloy steel.

Technical objects of the present disclosure are not limited to the technical objects described above, and other technical objects that are not described will be clearly understood by a person skilled in the art from the description below.

An exemplary embodiment of the present inventive concept provides alloy steel for a constant velocity joint outer wheel comprising, based on a total weight of the alloy steel, 0.50 to 0.60 wt % C (carbon), 0.15 to 0.35 wt % Si (silicon), 0.4 to 0.8 wt % Mn (manganese), more than 0 to 0.03 wt % P (phosphorus), more than 0 to 0.035 wt % S (sulfur), more than 0 to 0.3 wt % Cu (copper), more than 0 to 0.00002 wt % O (oxygen), and a balance of Fe (iron).

The alloy steel may further comprise 0.2 to 0.6 wt % Cr (chromium).
The alloy steel may further comprise 0.15 to 0.30 wt % Mo (molybdenum).
The alloy steel may further comprise 0.2 to 0.6 wt % Ni (nickel).
The alloy steel may further comprise 0.005 to 0.05 wt % Ti (titanium).
The alloy steel may further comprise 0.000010 to 0.000040 wt % B (boron).
The alloy steel may further comprise 0.2 to 0.6 wt % Cr (chromium), 0.15 to 0.30 wt % Mo (molybdenum), 0.2 to 0.6 wt % Ni (nickel), 0.005 to 0.05 wt % Ti (titanium), and 0.000010 to 0.000040 wt % B (boron).
Another exemplary embodiment of the present inventive concept provides a method of manufacturing alloy steel for a constant velocity joint outer wheel, the method comprising steps of: mixing materials of the alloy steel; forging the alloy steel; quenching and tempering heat-treating the forged alloy steel; and high frequency heat-treating the alloy steel subjected to quenching and tempering heat-treating.
In the high frequency heat-treating, MHN/(2−(X/Y)) may be 3.9 to 4.3, where MHN is a material hardenability index expressed by the following Equation:

MHN=3.0×C(wt %)+2.0×Mn(wt %)+1.5×Cr(wt %)+2.5×Mo(wt %)+4.0×Ti(wt %);

X is a new power output, the new power output being a high frequency heat-treating power output condition to be managed in an outer wheel manufacturing process for each material component of the alloy steel, and Y is a reference power output, the reference power output being 170 kW.
According to another embodiment in the present disclosure, a transmission for a vehicle manufactured by using the alloy steel may improve durability of the vehicle and prolong a life of the vehicle and thus prevent environmental pollution.

### BRIEF DESCRIPTION OF THE DRAWINGS

FIG. 1 is a constitutional view of a constant velocity joint for a vehicle according to the related art.

FIG. 2 is a flowchart of a manufacturing process of an alloy steel used in a constant velocity joint outer wheel for a vehicle according to an exemplary embodiment in the present disclosure.

### DETAILED DESCRIPTION OF THE EMBODIMENTS

Hereinafter, preferred exemplary embodiments of the present inventive concept will be described in detail with reference to the accompanying drawings. Prior to this, terms or words used in the present specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own inventive concept in the best manner. Accordingly, the embodiment described in the present specification and the constitution illustrated in the drawings are just the most preferred embodiment of the present inventive concept but do not represent all technical spirits of the present inventive concept. Therefore, it should be understood that there are various equivalents and modifications replacing the embodiments at the time of filing of the present application.

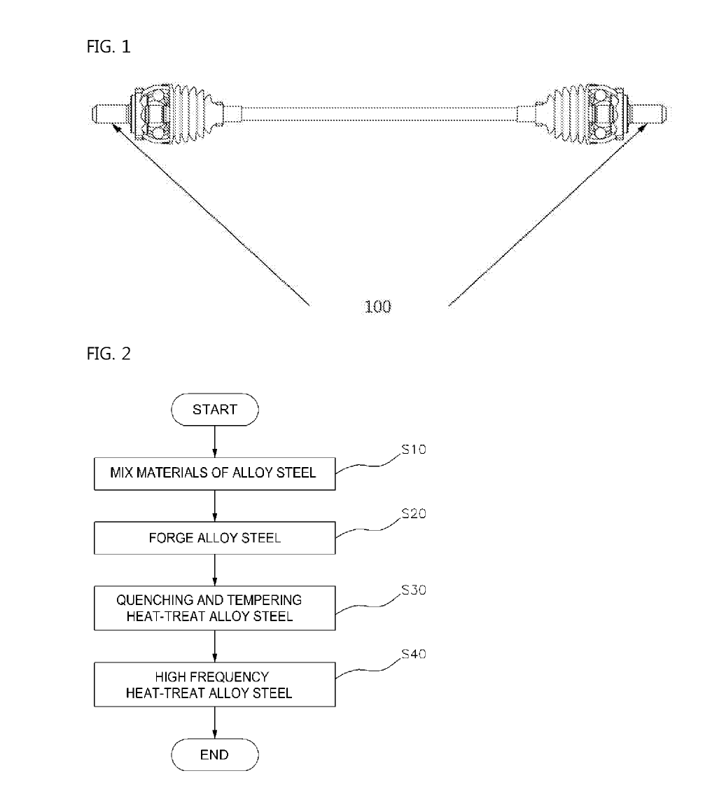

FIG. 1 is a constitutional view illustrating a constant velocity joint according to the related art. The constant velocity joint is used as a front axle of a front-wheel-drive car, and refers to a device mechanically connecting the axles in order to transfer a torque between the two axles. In more detail, the constant velocity joint is a universal joint uniformly performing power transmission without a change in rotational angular velocity between driven axles that are not on a straight line with a front driving axle, and means that the universal joints having a large corrugation angle are attached to both ends of the axle to offset the change in rotational angular velocity.

As illustrated in FIG. 1, the constant velocity joint is constituted by an outer wheel 100, an inner wheel ball, and a cage. Among them, the outer wheel of the constant velocity joint is a portion to which the largest load of a vehicle is applied. Therefore, in order to secure safety of the vehicle, rigidity of the outer wheel portion needs to be improved.

As requirements for solving the aforementioned problems, it is required that the material is a carbon steel, and through high frequency heat-treating, surface hardness is 58 to 63 HRC and an effective hardening depth is 3.5 to 5.5 mm. Moreover, it is required that after a distortion test evaluation is performed 1 million times, there is no abnormality, or durability of distortion fatigue strength of 350 Nm or more is required.

An exemplary embodiment in the present disclosure satisfies the aforementioned requirements, and relates to alloy steel used in a highly tough constant velocity joint outer wheel and a method of manufacturing the same, and in one aspect, the present disclosure relates to alloy steel used in a highly tough constant velocity joint outer wheel.

In order to solve the aforementioned problems, the alloy steel used to manufacture the highly tough constant velocity joint outer wheel may be constituted to include, based on the total weight of the alloy steel, Fe (iron) as a main component, 0.50 to 0.60 wt % of C (carbon), 0.15 to 0.35 wt % of Si (silicon), 0.4 to 0.8 wt % of Mn (manganese), more than 0 wt % and 0.03 wt % or less of P (phosphorus), more than 0 wt % and 0.035 wt % or less of S (sulfur), more than 0 wt % and 0.3 wt % or less of Cu (copper), more than 0 wt % and 0.00002 wt % or less of O (oxygen), and an inevitable impurity.

According to an exemplary embodiment, an alloy steel may be formed by selectively adding one or more of 0.2 to 0.6 wt % of Cr (chromium), 0.15 to 0.30 wt % of Mo (molybdenum), 0.2 to 0.6 wt % of Ni (nickel), 0.005 to 0.05 wt % of Ti (titanium), or 0.000010 to 0.000040 wt % of B (boron).

In more detail, the reason why a numerical value of a component constituting the alloy steel according to the present inventive concept is limited is as follows.

(1) 0.50 to 0.60 wt % of C (Carbon)

C (carbon) is the strongest interstitial matrix strengthening element among chemical components, and is combined with an element such as Cr (chromium) to form a carbide and thus improve strength, hardness, and the like and may increase surface hardness when carburizing and generate a precipitate carbide.

For the aforementioned role, the content of C (carbon) may be about 0.50 to 0.60 wt % based on the total weight of the alloy steel. Herein, when the content of C (carbon) is less than about 0.50 wt %, strength of the alloy steel may be reduced and it may be difficult to secure hardness. On the other hand, when the content of C (carbon) is more than about 0.60 wt %, core hardness of the alloy steel is increased, and this may reduce total toughness of the alloy steel.

(2) 0.15 to 0.35 wt % of Si (Silicon)

Si (silicon) may hinder carburizing when added in an excessive amount, but may suppress formation of a pin hole of the alloy steel as a deoxidizer, increasing strength of the alloy steel by a solid-solution strengthening effect by being solid-dissolved in a matrix, and increasing activity of C (carbon) and the like.

For the aforementioned role, the content of Si (silicon) may be about 0.15 to 0.35 wt % based on the total weight of the alloy steel. Herein, when the content of Si (silicon) is less than about 0.15 wt %, an effect of Si (silicon) as a deoxidizer hardly exists, and on the other hand, when the content of Si (silicon) is more than about 0.35 wt %, the solid-solution strengthening effect of the matrix is excessively increased to reduce formability, a carburizing property, and the like.

(3) 0.4 to 0.8 wt % of Mn (Manganese)

Mn (manganese) may improve a quenching property of the alloy steel and improve strength of the alloy steel and the like. For the aforementioned role, the content of Mn (manganese) may be about 0.4 to 0.8 wt %.

Herein, when the content of Mn (manganese) is less than about 0.4 wt %, a sufficient quenching property and the like may not be secured, and on the other hand, when the content of Mn (manganese) is more than about 0.8 wt %, grain boundary oxidation may occur and mechanical properties of the alloy steel may be reduced.

(4) More than 0 wt % and 0.03 wt % or less of P (Phosphorus)

P (phosphorus) may induce crystal grain boundary segregation to reduce toughness of the alloy steel.

In order to prevent this problem, the content of P (phosphorus) may be limited to more than 0 wt % and 0.03 wt % or less. Herein, when the content of P (phosphorus) is more than about 0.03 wt %, toughness of the alloy steel may be reduced.

(5) More than 0 wt % and 0.035 wt % or less of S (Sulfur)

S (sulfur) increases machinability of the alloy steel to facilitate processing, but may reduce toughness of the alloy steel due to grain boundary segregation and may reduce the fatigue life of the alloy steel by reacting with Mn (manganese) to form MnS.

In order to solve this problem, the content of S (sulfur) may be limited to more than 0 wt % and 0.035 wt % or less. Herein, when the content of S (sulfur) is more than 0.035 wt %, toughness of the alloy steel may be reduced that may reduce the fatigue life of the steel.

(6) More than 0 wt % and 0.3 wt % or less of Cu (Copper)

Cu (copper) improves hardenability of the alloy steel and the like.

For the aforementioned role, the content of Cu (copper) may be limited to more than 0 wt % and 0.3 wt % or less. Herein, when the content of Cu (copper) is more than 0.3 wt %, since a solid-solution limitation is exceeded, a strength improvement effect of the steel is saturated, and thus manufacturing costs are increased and red shortness may be caused.

(7) More than 0 wt % and 0.001 wt % or Less of O (Oxygen)

O (oxygen) increases the generation of non-metallic inclusions of the alloy steel, that is, generation of impurities, to reduce cleanliness and durability and degrade the alloy steel through contact fatigue.

In order to prevent this problem, the content of O (oxygen) may be limited to 0.00002 wt % or less. Herein, when the content of O (oxygen) is more than 0.00002 wt % or more, the impurity of the alloy steel is increased to degrade the alloy steel due to contact fatigue.

(8) 0.2 to 0.6 wt % of Cr (Chromium)

Cr (chromium) improves a quenching property of the alloy steel, providing hardenability, and simultaneously, micronizing the alloy steel and spheroidizing the alloy steel by heat-treatment. Further, chromium hardens a lamella in cementite.

For the aforementioned role, the content of Cr (chromium) may be 0.2 to 0.6 wt %. Herein, when the content of Cr (chromium) is less than 0.2 wt %, the quenching property and hardenability may be limited and sufficient micronization and spheroidizing of the alloy steel may not be obtained. On the other hand, when the content of Cr (chromium) is more than 0.6 wt %, according to an increase in content, toughness and machinability are reduced and a strength increase effect is insignificant, and thus manufacturing costs are increased.

(9) 0.15 to 0.30 wt % of Mo (Molybdenum)

Mo (molybdenum) increases a quenching property of the alloy steel to improve hardenability and toughness of the alloy steel and the like after tempering and provide brittleness resistance. Further, molybdenum reduces activity of carbon.

For the aforementioned role, the content of Mo (molybdenum) may be about 0.15 to 0.30 wt %. Herein, when the content of Mo (molybdenum) is less than about 0.15 wt %, hardenability and toughness of the alloy steel, and the like, may not be sufficiently secured. On the other hand, when the content of Mo (molybdenum) is more than about 0.5 wt %, toughness, processability (machinability), and productivity of the alloy steel, and the like are reduced and an increase effect of the content is insignificant, and thus manufacturing costs are increased.

(10) 0.2 to 0.6 wt % of Ni (Nickel)

Ni (nickel) micronizes crystal grains of the alloy steel and may be solid-dissolved in austenite and ferrite to strengthen a matrix. Moreover, nickel improves toughness to an impact at low temperatures and hardenability, and reduces a temperature of an Al transformation point to expand austenite. Further, nickel increases the activity of carbon.

For the aforementioned role, the content of Ni (nickel) may be about 0.2 to 0.6 wt %. Herein, when the content of Ni (nickel) is less than about 0.2 wt %, it may be difficult to sufficiently obtain an effect of micronization of the crystal grains and it may be difficult to obtain a sufficient improvement effect such as solid-solution strengthening and matrix strengthening. On the other hand, when the content of Ni (nickel) is more than about 0.6 wt %, red shortness may be caused in the alloy steel and an increase effect of the content is insignificant, and thus manufacturing costs are increased.

(11) 0.005 to 0.05 wt % of Ti (Titanium)

Ti (titanium) forms a carbonitride to suppress growth of the crystal grains and improve high temperature stability, strength, toughness, and the like.

For the aforementioned role, the content of Ti (titanium) may be 0.005 to 0.05 wt %. Herein, when the content of Ti (titanium) is more than about 0.05 wt %, a coarse precipitate may be formed, and due to a reduction in low temperature impact property and saturation of the effect thereof, manufacturing costs are increased.

(12) 0.00001 to 0.00004 wt % of B (Boron)

B (boron) improves hardenability, tensile strength, impact resistance, and strength of the alloy steel, and the like, and prevents corrosion. Further, boron facilitates high frequency heat-treating due to an increase in quenching property. However, weldability may be reduced.

For these reasons, the content of B (boron) may be about 0.00001 to 0.00004 wt %. Herein, when the content of B (boron) is less than about 0.00001 wt %, it may be difficult to secure sufficient hardenability of the alloy steel, and on the other hand, when the content of B (boron) is more than about 0.00004 wt %, toughness and ductility of the alloy steel and the like may be reduced to reduce impact resistance and durability may be reduced due to segregation.

Since the alloy steel having the aforementioned constitution according to the present disclosure has superior strength, tensile strength, impact strength, and durability, the alloy steel may be applied to vehicle parts and the like, and particularly, the alloy steel may be applied to a constant velocity joint outer wheel of a vehicle.

In addition to this, in another aspect, the present disclosure relates to a method of manufacturing alloy steel used to manufacture a constant velocity joint outer wheel of a vehicle.

The alloy steel used to manufacture the constant velocity joint outer wheel of the vehicle may be appropriately manufactured by a person with ordinary skill in the art with reference to a publicly known technology.

FIG. 2 is a flowchart of the method of manufacturing the alloy steel used to manufacture the constant velocity joint outer wheel of the vehicle. To be more specific, the method of manufacturing the alloy steel used to manufacture the constant velocity joint outer wheel for the vehicle includes mixing materials of the alloy steel (S10); forging the alloy steel (S20); quenching and tempering heat-treating the forged alloy steel (S30); high frequency heat-treating the alloy steel subjected to quenching and tempering heat-treating (S40), and the like.

In the mixing of the materials of the alloy steel (S10), as described above, the materials of the alloy steel may be mixed by adding one or more elements selected from Cr (chromium), Mo (molybdenum), Ni (nickel), Ti (titanium), and B (boron) to C (carbon), Si (silicon), Mn (manganese), P (phosphorus), S (sulfur), Cu (copper), or O (oxygen). The alloy component may be added to the material to micronize crystal grains of the alloy steel, and through this, tensile strength, impact strength, and distortion strength of the material may be improved.

In the forging of the alloy steel (S20), the constant velocity joint is manufactured to have a desired form through forging using the related art.

Meanwhile, in a method of manufacturing alloy steel used to manufacture a constant velocity joint outer wheel for a vehicle according to the related art, the alloy steel is manufactured by sequentially performing the steps of: mixing materials of the alloy steel in the related art (S10); forging the alloy steel (S20); and high frequency heat-treating the forged alloy steel (S40).

However, when the alloy steel is manufactured by the related art, tempered martensite is generated as a microstructure of a surface, but in a microstructure of a core portion, ferrite and perlite are generated. On the other hand, when the alloy steel is manufactured according to the manufacturing method of the present inventive concept, the tissue is homogenized due to the quenching and tempering heat-treating (S30), and thus in both the microstructures of the surface and the core portion, tempered martensite is generated. The tempered martensite is a material having hardness next to that of martensite, a high elastic limit, and toughness that is better than that of martensite. Therefore, in the case of the manufacturing method of the present inventive concept, it can be confirmed that in the microstructure of the core portion, tempered martensite is generated to increase strength and toughness. That is, in the quenching and tempering heat-treating (S30), as compared to the alloy steel in the related art, hardness of the core portion is further increased to increase distortion strength.

Further, in the high frequency heat-treating (S40), unlike the related art, the high frequency heat-treating should be performed under a special condition. A goal of the high frequency heat-treating of the present inventive concept is surface hardness of 58 to 63 HRC and a hardening depth of 3.5 to 5.5 mm. In order to satisfy this, a parameter of a material hardenability index (MHN) is used as a reference adjusting power output during high frequency heat-treating. This is a value changed according to a component ratio of an element of the alloy, and shows a prevention effect of defects by managing the quality of the alloy steel. Further, if a high frequency heat-treating process is optimized by using the material hardenability index, as compared to the related art, impact strength, distortion strength, and durability may be improved.

MHR=3.0C(wt %)+2.0×Mn(wt %)+1.5×Cr(wt %)+2.5×Mo(wt %)+4.0×Ti(wt %) [Equation 1]

Equation 1 is an equation showing the material hardenability index (MHN). In order to optimize the high frequency heat-treating (S40), as the material hardenability index is increased, power output of high frequency heat-treating is reduced on the basis of reference power, and as the material hardenability index is reduced, power output of high frequency heat-treating is increased on the basis of reference power.

TABLE 1

| | | | | | | | | Heat-treating condition (on |
|---|---|---|---|---|---|---|---|---|
| | Component | | | | | | | the basis of hardening depth |
| | C | Si | Mn | Cr | Mo | Ti | MHN | of 4 to 5 mm) |
| Inventive | 0.50 | 0.15 | 0.4 | 0.2 | 0.15 | 0.005 | 3.00 | 1.3 to 1.6 times on the basis of |
| Example 1 | | | | | | | | reference power |
| Inventive | 0.55 | 0.20 | 0.6 | 0.4 | 0.22 | 0.02 | 4.12 | 0.9 to 1.2 times on the basis of |
| Example 2 | | | | | | | | reference power |
| Inventive | 0.40 | 0.35 | 0.8 | 0.6 | 0.30 | 0.05 | 5.25 | 0.8 to 0.9 times on the basis of |
| Example 3 | | | | | | | | reference power |

Table 1 shows the condition of high frequency heat-treating according to the alloy component of the present inventive concept. The condition of high frequency heat-treating is shown on the basis of the hardening depth of 4 to 5 mm, as the material hardenability index is increased, power output of high frequency heat-treating is reduced, and as the material hardenability index is reduced, higher power output of high frequency heat-treating is applied.

In order to form the optimized condition of high frequency heat-treating through data of Table 1, the parameter Z is drawn by using the material hardenability index (MHN).

$$Z = \frac{MHN}{2 - \frac{X}{Y}} \begin{matrix} \\ \end{matrix} \qquad [ Equation 2 ]$$

X: new power output

Y: reference power output

[symbol]

In Equation 2, MHN means the material hardenability index (MHN). Reference power output (kW) is power output of high frequency heat-treating, and there is a reference power output deviation between high frequency apparatuses, and thus reference power output should be designated after a heat-treating test. The following Table 2 is a condition table of an experiment suggesting reference power output. The highly tough constant velocity joint outer wheel has optimum physical properties only when the hardening depth corresponds to 3.9 to 4.6 mm.

TABLE 2

| | | | | | | | | Reference | |
|---|---|---|---|---|---|---|---|---|---|
| | Alloy component | | | | | | | power | Hardening depth |
| | C | Si | Mn | Cr | Mo | Ti | MHN | output (kW) | (mm) |
| Inventive | 0.55 | 0.20 | 0.6 | 0.4 | 0.22 | 0.02 | 4.12 | 170 | 4.1 to 4.3 |
| Example 2 | | | | | | | | | |

Example 2 of Table 2 takes an intermediate value in each alloy component range of the present inventive concept, and in this case, a suitable new power output value is found in each Inventive Example having power output of high frequency heat-treating as reference power output. New power output means a power output condition of high frequency heat-treating, which is the most suitable to be managed during a manufacturing process of the outer wheel for each material component of the alloy steel.

When the parameter Z value used to search the optimum condition of high frequency heat-treating is 3.9 to 4.2, toughness strength, impact strength, and distortion fatigue strength are maximized. Accordingly, if the parameter Z value is increased, that is, when the power output of high frequency heat-treating is increased, the material of the alloy steel becomes coarse to reduce distortion durability, and if the parameter Z value is reduced, that is, in the case where power output of high frequency heat-treating is reduced, the hardening depth becomes insufficient to reduce distortion strength. In addition to this, even for the alloy steels having the same component, a difference between component ratios of the alloy steel occurs for each Inventive Example, and thus the hardening depth according to high frequency heat-treating is changed by the component ratio of the alloy steel. Therefore, for each component ratio of the alloy steel, a suitable condition of high frequency heat-treating needs to be drawn.

TABLE 3

| | Component ratio of alloy steel | | | | | | | | Evaluation result | | | |
|---|---|---|---|---|---|---|---|---|---|---|---|---|
| | (wt %) | | | | | | | | | | Distortion | Notice |
| | | | | | | | | B | Tensile | Impact | fatigue | Evaluation |
| Classification | C | Si | Mn | Cr | Mo | Ni | Ti | (ppm) | strength | strength | strength | result |
| Related | 0.52 | 0.15 | 0.7 | 0.1 | — | — | — | — | 790 MPa | 60 J | 300 Nm | |
| art | to | to | to | to | | | | | or | or | or | |
| | 0.56 | 0.35 | 0.9 | 0.2 | | | | | more | more | more | |
| Present | 0.50 | 0.15 | 0.4 | 0.2 | 0.15 | 0.2 | 0.005 | 10 | 830 MPa | 70 J | 350 Nm | |
| Inventive | to | to | to | to | to | to | to | to | or | or | or | |
| Concept | 0.60 | 0.35 | 0.8 | 0.6 | 0.30 | 0.6 | 0.05 | 40 | more | more | more | |
| Inventive | 0.53 | 0.25 | 0.70 | 0.22 | 0.20 | 0.30 | 0.01 | 21 | 873 | 76 | 380 Nm | Suitable |
| Example 4 | | | | | | | | | | | | |
| Inventive | 0.53 | 0.25 | 0.70 | 0.51 | 0.28 | 0.50 | 0.04 | 21 | 899 | 80 | 392 Nm | Suitable |
| Example 5 | | | | | | | | | | | | |
| Comparative | 0.53 | 0.25 | 0.75 | 0.12 | — | — | — | — | 811 | 66 | 320 Nm | Unsuitable |
| Example 1 | | | | | | | | | | | | |
| Comparative | 0.55 | 0.28 | 0.70 | 0.7 | 0.4 | 0.5 | 0.01 | 21 | 898 | 67 | 361 Nm | Unsuitable |
| Example 2 | | | | | | | | | | | | |
| Comparative | 0.55 | 0.28 | 0.70 | 0.1 | 0.1 | 0.1 | — | — | 814 | 68 | 323 Nm | Unsuitable |
| Example 3 | | | | | | | | | | | | |
| Comparative | 0.55 | 0.28 | 0.70 | 0.3 | 0.1 | 0.1 | — | — | 834 | 68 | 327 Nm | Unsuitable |
| Example 4 | | | | | | | | | | | | |
| Comparative | 0.55 | 0.28 | 0.70 | 0.3 | 0.2 | 0.1 | — | — | 866 | 69 | 336 Nm | Unsuitable |
| Example 5 | | | | | | | | | | | | |
| Comparative | 0.55 | 0.28 | 0.70 | 0.3 | 0.2 | 0.3 | — | — | 861 | 70 | 345 Nm | Unsuitable |
| Example 6 | | | | | | | | | | | | |
| Comparative | 0.55 | 0.28 | 0.70 | 0.3 | 0.2 | 0.8 | 0.01 | — | 861 | 77 | 360 Nm | Suitable |
| Example 7 | | | | | | | | | | | | (disadvantageous |
| | | | | | | | | | | | | in |
| | | | | | | | | | | | | terms of |
| | | | | | | | | | | | | prime |
| | | | | | | | | | | | | costs) |

Table 3 is a table where the Comparative Examples by the related art and the Examples of the present inventive concept are compared. The related art is alloy steel manufactured by the manufacturing method in the related art by using the component ratio described in the aforementioned Table. In this case, the alloy steel of the related art shows the result that tensile strength is 790 MPa or more, impact strength is 60 J or more, and distortion fatigue strength is 300 Nm or more. On the other hand, the present inventive concept shows the result that in the case where the alloy steel is manufactured by the manufacturing method of the present inventive concept by using the component ratio described in Table 3, tensile strength is 830 MPa or more, impact strength is 70 J or more, and distortion fatigue strength is 350 Nm or more. In light of this, in the present inventive concept, as compared to the related art, the alloy element is added to improve tensile strength by about 5% and improve impact strength by 15% or more. Further, distortion fatigue strength is improved by about 17%.

It can be confirmed that Inventive Examples 1 and 2 satisfy the evaluation condition (that is, tensile strength is 830 MPa or more, impact strength is 70 J or more, and distortion fatigue strength is 350 Nm or more). However, in Comparative Example 1 that is the related art, it can be confirmed that tensile strength, impact strength and distortion fatigue strength that are the evaluation result do not satisfy the evaluation condition. In Comparative Example 2, Cr (chromium) and Mo (molybdenum) are added in an excessive amount. As a result, it can be confirmed that all of tensile strength, impact strength, and distortion fatigue strength do not satisfy the evaluation condition. In Comparative Example 3, Cr, Mo, and Ni are added in a small amount as compared to the Inventive Examples, and Ti and B are not added. As a result, it can be confirmed that all of tensile strength, impact strength, and distortion fatigue strength are not satisfied. In Comparative Example 4, Mo and Ni are added in a small amount as compared to the Inventive Examples, and Ti and B are not added. As a result, it can be confirmed that impact strength and distortion fatigue strength do not satisfy the evaluation condition. In Comparative Example 5, Ni is added in a small amount as compared to the Inventive Examples, and Ti and B are not added. As a result, it can be confirmed that impact strength and distortion fatigue strength do not satisfy the evaluation condition. In Comparative Example 6, as compared to the components of the Inventive Examples, Ti and B are not added. As a result, it can be confirmed that distortion fatigue strength does not satisfy the evaluation condition. In Comparative Example 7, Ni is added in an excessive amount as compared to the Inventive Examples, and B is not added. As a result, all the evaluation conditions are satisfied, but since costly Ni was added in an excessive amount, production costs of the alloy steel were increased, and thus this was not suitable.

TABLE 4

| | | | | | | | | | Evaluation |
|---|---|---|---|---|---|---|---|---|---|
| | Chemical component (wt %) | | | | | | | | result |
| | | | | | | | | B | Distortion |
| Classification | C | Si | Mn | Cr | Mo | Ni | Ti | (ppm) | fatigue life |
| Related art | 0.52 | 0.15 | 0.7 | 0.1 | — | — | — | — | 1 million |
| | to | to | to | to | | | | | times or |
| | 0.56 | 0.35 | 0.9 | 0.2 | | | | | more |
| Present | 0.50 | 0.15 | 0.4 | 0.2 | 0.15 | 0.2 | 0.005 | 10 | 1.5 million |
| Inventive | to | to | to | to | to | to | to | to | times or |
| Concept | 0.60 | 0.35 | 0.8 | 0.6 | 0.30 | 0.6 | 0.05 | 40 | more |
| Inventive | 0.55 | 0.28 | 0.70 | 0.32 | 0.2 | 0.3 | 0.01 | 21 | 1.6 million |
| Example 3 | | | | | | | | | times |
| Comparative | 0.53 | 0.25 | 0.75 | 0.12 | — | — | — | — | 1.1 million |
| Example 1 | | | | | | | | | times |
| Comparative | 0.55 | 0.28 | 0.70 | 0.1 | 0.1 | 0.1 | — | — | 1.24 |
| Example 3 | | | | | | | | | million |
| | | | | | | | | | times |
| Comparative | 0.55 | 0.28 | 0.70 | 0.7 | 0.5 | 0.5 | 0.01 | 21 | 1.4 million |
| Example 8 | | | | | | | | | times |

Table 4 is a table where the Inventive Examples and the Comparative Examples that are the related art are compared. The distortion fatigue life is a means for evaluating durability, and in the case of the highly tough constant velocity joint outer wheel, it is required that there is no abnormality even after the distortion test is performed 1 million times.

By the component ratio of the alloy steel of the present inventive concept, it can be confirmed that the distortion fatigue life is 1.60 million times or more. On the other hand, in Comparative Example 1, Cr was added in a small amount as compared to the Inventive Examples, and Mo, Ni, Ti, and B were not added. As a result, the distortion fatigue life was just 1.10 million times, thus not satisfying the reference of the Inventive Examples. In Comparative Example 3, Cr, Mo, and Ni were added in a small amount as compared to the Inventive Examples, and Ti and B were not added. As a result, the distortion fatigue life was just 1.24 million times. In Comparative Example 8, Cr and Mo were added in an excessive amount as compared to the Inventive Examples. As a result, the distortion fatigue life was just 1.40 million times.

The present inventive concept includes Fe (iron) as a main component, C (carbon), Si (silicon), Mn (manganese), P (phosphorus), S (sulfur), Cu (copper), Cr (chromium), Mo (molybdenum), Ni (nickel), Ti (titanium), B (boron), O (oxygen), and an inevitable impurity. Accordingly, there are merits in that physical properties such as toughness strength, impact strength, distortion fatigue strength, or a distortion fatigue life are improved to improve durability, promote stability and a lengthened life of the material, and reduce manufacturing costs.

As described above, the present inventive concept has been described in relation to specific embodiments, but the embodiments are only illustration and the present inventive concept is not limited thereto. Embodiments described may be changed or modified by those skilled in the art to which the disclosure pertains without departing from the scope of the present inventive concept, and various alterations and modifications are possible within the technical spirit of the present inventive concept and the equivalent scope of the claims which will be described below.

What is claimed is:

1. Alloy steel for a constant velocity joint outer wheel comprising:
based on a total weight of the alloy steel,
0.50 to 0.60 wt % C (carbon),
0.15 to 0.35 wt % Si (silicon),
0.4 to 0.8 wt % Mn (manganese),
more than 0 to 0.03 wt % P (phosphorus),
more than 0 to 0.035 wt % S (sulfur),
more than 0 to 0.3 wt % Cu (copper),
more than 0 to 0.00002 wt % O (oxygen),
and a balance of Fe (iron).

2. The alloy steel of claim 1, further comprising:
0.2 to 0.6 wt % Cr (chromium).

3. The alloy steel of claim 1, further comprising:
0.15 to 0.30 wt % Mo (molybdenum).

4. The alloy steel of claim 1, further comprising:
0.2 to 0.6 wt % Ni (nickel).

5. The alloy steel of claim 1, further comprising:
0.005 to 0.05 wt % Ti (titanium).

6. The alloy steel of claim 1, further comprising:
0.000010 to 0.000040 wt % B (boron).

7. The alloy steel of claim 1, further comprising:
0.2 to 0.6 wt % Cr (chromium),
0.15 to 0.30 wt % Mo (molybdenum),
0.2 to 0.6 wt % Ni (nickel),
0.005 to 0.05 wt % Ti (titanium), and
0.000010 to 0.000040 wt % B (boron).

8. A method of manufacturing alloy steel for a constant velocity joint outer wheel, the method comprising steps of:
mixing materials of the alloy steel of claim 1;
forging the alloy steel;
quenching and tempering heat-treating the forged alloy steel; and
high frequency heat-treating the alloy steel subjected to quenching and tempering heat-treating.

9. A method of manufacturing alloy steel for a constant velocity joint outer wheel, the method comprising steps of:
mixing materials of the alloy steel of claim 2;
forging the alloy steel;
quenching and tempering heat-treating the forged alloy steel; and
high frequency heat-treating the alloy steel subjected to quenching and tempering heat-treating.

10. A method of manufacturing alloy steel for a constant velocity joint outer wheel, the method comprising steps of:
mixing materials of the alloy steel of claim 3;
forging the alloy steel;
quenching and tempering heat-treating the forged alloy steel; and
high frequency heat-treating the alloy steel subjected to quenching and tempering heat-treating.

11. A method of manufacturing alloy steel for a constant velocity joint outer wheel, the method comprising steps of:
mixing materials of the alloy steel of claim 4;
forging the alloy steel;
quenching and tempering heat-treating the forged alloy steel; and
high frequency heat-treating the alloy steel subjected to quenching and tempering heat-treating.

12. A method of manufacturing alloy steel for a constant velocity joint outer wheel, the method comprising steps of:
mixing materials of the alloy steel of claim 5;
forging the alloy steel;
quenching and tempering heat-treating the forged alloy steel; and
high frequency heat-treating the alloy steel subjected to quenching and tempering heat-treating.

13. A method of manufacturing alloy steel for a constant velocity joint outer wheel, the method comprising steps of:
mixing materials of the alloy steel of claim 6;
forging the alloy steel;
quenching and tempering heat-treating the forged alloy steel; and
high frequency heat-treating the alloy steel subjected to quenching and tempering heat-treating.

14. A method of manufacturing alloy steel for a constant velocity joint outer wheel, the method comprising steps of:
mixing materials of the alloy steel of claim 7;
forging the alloy steel;
quenching and tempering heat-treating the forged alloy steel; and
high frequency heat-treating the alloy steel subjected to quenching and tempering heat-treating.

15. The method of claim 14, wherein, in the high frequency heat-treating, MHN/(2−(X/Y)) is 3.9 to 4.3, where MHN is a material hardenability index expressed by the following Equation:
MHN=3.0×C(wt %)+2.0×Mn(wt %)+1.5×Cr(wt %)+2.5×Mo(wt %)+4.0×Ti(wt %);
X is a new power output, the new power output being a high frequency heat-treating power output condition to be managed in an outer wheel manufacturing process for each material component of the alloy steel, and Y is a reference power output, the reference power output being 170 kW.
